(19) United States
(12) Patent Application Publication
(10) Pub. No.: US 2021/0263198 A1
(43) Pub. Date: Aug. 26, 2021

(54) LIQUID CRYSTAL-BASED LASER BEAM SCANNERS AND LASER SIGNAL RECEIVERS

(71) Applicant: BEIJING VOYAGER TECHNOLOGY CO., LTD., Beijing (CN)

(72) Inventors: Wenbin Zhu, Mountain View, CA (US); Yonghong Guo, Los Gatos, CA (US); Chao Wang, Mountain View, CA (US); Lingkai Kong, Mountain View, CA (US)

(73) Assignee: BEIJING VOYAGER TECHNOLOGY CO., LTD., Beijing (CN)

(21) Appl. No.: 16/802,444

(22) Filed: Feb. 26, 2020

(51) Int. Cl. G02B 3/08; G02B 5/30; F21V 9/08

(52) U.S. Cl. CPC G02B 3/08; F21V 9/08; G02B 5/3033

(57) ABSTRACT

Embodiments of the disclosure provide laser beam scanners and receivers for controlling the directions of laser beams. An exemplary scanner may include a first polarizer configured to polarize a laser beam emitted from a laser source. The scanner may also include first and second transparent electrodes disposed in parallel with the first polarizer. The first transparent electrode may be closer to the first polarizer than the second transparent electrode. The scanner may also include a liquid crystal disposed between the first and second transparent electrodes and configured to selectively alter at least one property of the laser beam polarized by the first polarizer in response to a signal applied to the first or second transparent electrodes. The signal may generate a predetermined pattern on the first or second electrode to direct the laser beam polarized by the first polarizer to a predetermined direction corresponding to the predetermined pattern.

### TECHNICAL FIELD

The present disclosure relates to Light Detection and Ranging (LiDAR) systems, and more particularly to, non-mechanical laser beam scanners and laser signal receivers in the LiDAR systems.

### BACKGROUND

Optical sensing systems such as LiDAR systems have been widely used in autonomous driving and producing high-definition maps. For example, a typical LiDAR system measures the distance to a target by illuminating the target with pulsed laser light beams and measuring the reflected pulses with a sensor such as a photodetector. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and/or high-definition map surveys.

A LiDAR system can detect objects in a field-of-view (FOV) by transmitting laser beams in multiple directions and measuring the reflected signals along the corresponding directions. For example, mechanical scanning systems such as a rotational scanner/receiver may be used to rotate a laser source and a photodetector to cover a desirable FOV. Other mechanical scanning systems used in LiDAR systems include galvo- and MEMS-based systems for steering laser beams. Such mechanical scanning systems, however, cannot achieve very high scanning rates due to the limitation of mechanically moving parts. The moving parts are also not very robust, leading to short lifespans and frequent operation failures. Further, mechanical scanning systems are generally expensive to make and maintain. Therefore, it is desirable to develop a non-mechanical laser beam steering mechanism to improve the performance and robustness, as well as lowering the cost.

Embodiments of the disclosure provide non-mechanical laser beam scanners and laser signal receivers using liquid crystals to achieve beam steering.

### SUMMARY

Embodiments of the disclosure provide a laser beam scanner. The laser beam scanner may include a first polarizer configured to polarize a laser beam emitted from a laser source. The laser beam scanner may also include first and second transparent electrodes disposed in parallel with the first polarizer. The first transparent electrode may be closer to the first polarizer than the second transparent electrode. The laser beam scanner may further include a liquid crystal disposed between the first and second transparent electrodes and configured to selectively alter at least one property of the laser beam polarized by the first polarizer in response to a signal applied to the first or second transparent electrode. The signal may generate a predetermined pattern on the first or second electrode to direct the laser beam polarized by the first polarizer to a predetermined direction corresponding to the predetermined pattern.

Embodiments of the disclosure also provide a laser beam receiver. The laser beam receiver may include first and second transparent electrodes disposed in parallel with each other. The laser beam receiver may also include a liquid crystal disposed between the first and second transparent electrodes and configured to selectively alter at least one property of a laser beam passing therethrough in response to a signal applied to the first or second transparent electrodes. The signal may generate a predetermined pattern on the first or second electrode to direct the laser beam from a predetermined direction toward a photodetector. The laser beam receiver may further include a first polarizer disposed in parallel with the first and second transparent electrodes and configured to polarize the laser beam passing through the liquid crystal.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system, according to embodiments of the disclosure.

FIG. 3 illustrates a schematic diagram of an exemplary laser beam scanner, according to embodiments of the disclosure.

FIGS. 4 and 5 illustrate exemplary Fresnel zone plates for steering laser beams, according to embodiments of the disclosure.

FIGS. 6 and 7 illustrate schematic diagrams of the laser beam scanner shown in FIG. 3 that is configured to emit oblique laser beams, according to embodiments of the disclosure.

FIG. 8 illustrates different types of Fresnel zone plates, according to embodiments of the disclosure.

FIG. 9 illustrates an exemplary Fresnel lens for steering laser beams based on phase modulation, according to embodiments of the disclosure.

FIGS. 10-12 illustrate schematic diagrams of an exemplary laser beam scanner using phase modulation based on Fresnel lens, according to embodiments of the disclosure.

FIGS. 13-15 illustrate schematic diagrams of an exemplary laser beam receiver using intensity modulation based on Fresnel zone plates, according to embodiments of the disclosure.

FIGS. 16-18 illustrate schematic diagrams of an exemplary laser beam receiver using phase modulation based on Fresnel lens, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

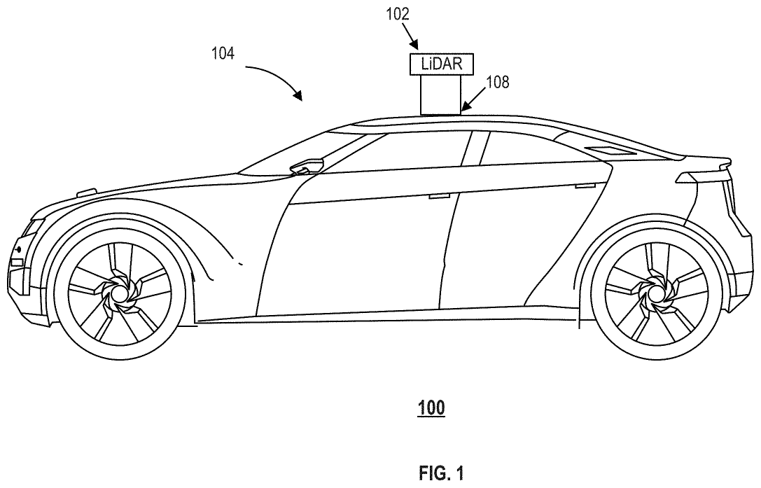

FIG. 1 illustrates a schematic diagram of an exemplary vehicle 100 equipped with a LiDAR system 102, according to embodiments of the disclosure. As illustrated in FIG. 1, vehicle 100 may be equipped with LiDAR system 102 mounted to body 104 via a mounting structure 108. Mounting structure 108 may be a mechanical or electro-mechanical device installed or otherwise attached to body 104 of vehicle 100. In some embodiments of the present disclosure, mounting structure 108 may use screws, adhesives, or other mounting mechanisms. It is contemplated that the manners in which LiDAR system 102 can be equipped on vehicle 100 are not limited by the example shown in FIG. 1 and may be modified depending on the types of LiDAR system 102 and/or vehicle 100 to achieve desirable 3D sensing performance. For example, in some embodiments, LiDAR system 102 may be integrated with vehicle 100 with no mounting structure 108.

Consistent with some embodiments, LiDAR system 102 may be configured to capture data as vehicle 100 moves along a trajectory. For example, a transmitter of LiDAR system 102 may be configured to scan the surrounding and acquire point clouds. LiDAR system 102 measures distance to a target by illuminating the target with pulsed laser light and measuring the reflected laser light signals with a receiver (e.g., based on time of flight, phase shift, etc.). Based on the distance information. LiDAR system 102 may generate a point cloud representing a 3D surface profile of the target. The laser light used by LiDAR system 102 may include ultraviolet, visible, or near infrared laser lights. As vehicle 100 moves along the trajectory, LiDAR system 102 may continuously emit/scan laser beams and receive returned laser signals.

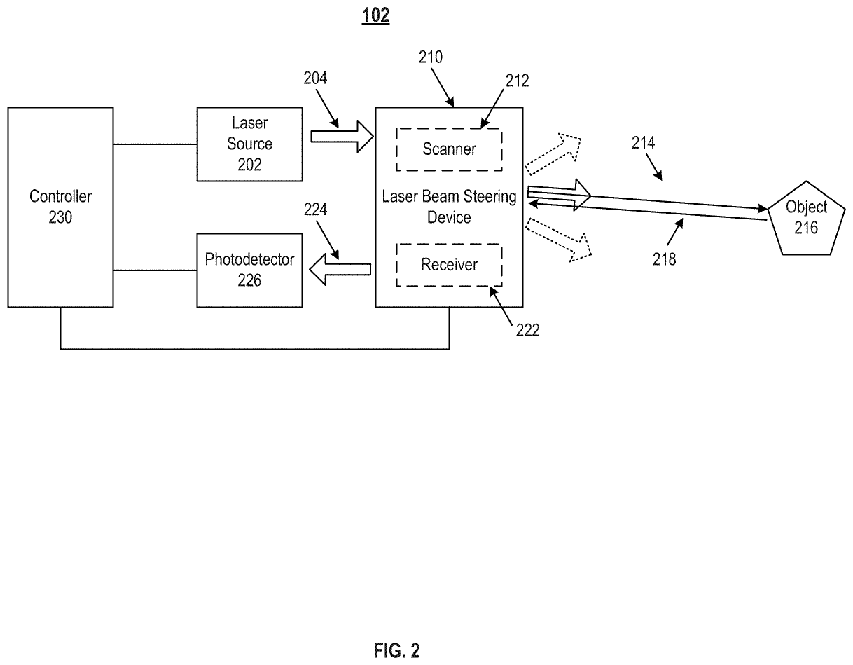

FIG. 2 illustrates a block diagram of an exemplary implementation of LiDAR system 102, according to embodiments of the disclosure. As shown in FIG. 2, LiDAR system 102 may include a laser source 202 for emitting a laser beam 204 (also referred to as a “native laser beam”). Laser source 202 may include any suitable light source that emits laser beam 204. For example, laser source 202 may include a pulsed laser diode (PLD). A PLD may be a semiconductor device similar to a light-emitting diode (LED) in which the laser beam is created at the diode's junction. A PLD may include a PIN diode in which the active region is in the intrinsic (I) region, and the carriers (electrons and holes) are pumped into the active region from the N and P regions, respectively. Depending on the semiconductor materials, the wavelength of laser beam 204 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, or 848 nm. In some embodiments, laser source 202 may generate a pulsed laser beam in the ultraviolet, visible, or near infrared wavelength range.

Laser beam 204 emitted by laser source 202 may be directed into multiple directions (e.g., one direction at a time) by a scanner 212. For example, laser beam 204 may be incident to scanner 212 along an incident direction, and scanner 212 may direct the incident laser beam in another direction in a controllable manner. In another example, laser beam 204 emitted by laser source 202 may be omnidirectional. In this case, scanner 212 may collimate or otherwise change the omnidirectional laser beam into a directional laser beam along a particular direction and be able to alter the direction of the resulting directional laser beam in a controllable manner. In this way, LiDAR system 102 may scan the surroundings using directional laser beams, such as laser beam 214, to detect objects, such as object 216, present in the surroundings. Object 216 may include a wide range of materials including, for example, non-metallic objects, rocks, rain, chemical compounds, aerosols, clouds and even single molecules. The wavelength of laser beam 214 may vary based on the composition of object 216.

Laser beam 214 directed to object 216 may be reflected by object 216 via, for example, backscattering, such as Rayleigh scattering, Mie scattering, Raman scattering, and fluorescence. The reflected laser signal 218 may return back toward LiDAR system 102 and be captured by a receiver 222. Receiver 222 may selectively receive laser signals coming from multiple directions (e.g., one direction at a time) to generate a returned laser beam 224. In some embodiment, receiver 222 may direct returned laser beam 224 toward a photodetector 226 for measurement of light intensity, time of flight, phase, waveform, etc. Photodetector 226 may include an avalanche photodiode (APD), such as a single photon avalanche diode (SPAD), a SPAD array, or a silicon photo multiplier (SiPM). Photodetector 226 may convert light signals into electrical signals, which may be transmitted to a controller 230 for processing and analysis. Controller 230 may also control the operation of laser source 202, photodetector 226, scanner 212, and/or receiver 222.

Both scanner 212 and receiver 222 may function to steer a laser beam toward multiple controllable directions. Thus, both scanner 212 and receiver 222 may also be referred to as a laser beam steering device 210. As used herein, “steering” a laser beam refers to controlling the direction of the laser beam, either directing toward or receiving from the surroundings of LiDAR system 102. In some embodiments, scanner 212 and receiver 222 may be separate components, each being disposed within its own light pass to control the direction of laser beams. In some embodiments, scanner 212 and receiver 222 may be the same device (e.g., referred to as laser beam steering device 210) functioning in a reciprocal manner depending on the direction of the incident laser beam. When the incident laser beam is from laser source 202, such as laser beam 204, laser beam steering device 210 may function as scanner 212 configured to steer (e.g., control) the direction of the laser beam toward the surroundings of LiDAR system 102, thereby scanning the surrounding environment using multiple laser beams (e.g., pulses) directed into multiple directions. On the other hand, when a laser beam is incident from the surrounding environment, such as laser signals reflected from object 216, laser beam steering device 210 may function as receiver 222 configured to receive the reflected laser signals coming from multiple directions (e.g., one direction at a time) and direct the received laser signals toward photodetector 226. In some embodiments, controller 230 may control the steering of the laser beam directions to implement the scanning and/or detecting functions in a field-of-view (FOV) of LiDAR system 102. The FOV may be defined by the range of directions at which scanner 212 and/or receiver 222 steer the laser beams. Controller 252 may determine the distance of object 216 from LiDAR system 102 based on signals received from photodetector 226. For example, the distance between object 216 and LiDAR system 102 may be calculated based on the speed of light, the direction (e.g., scanning angle) of laser beam 214, the round-trip travel time of laser beam 214/218, and/or the intensity of returned laser beam 224.

To obtain a desired coverage of the surroundings and/or the resolution of the scanning/sensing result, the span of the scanning angles of laser beam 214, e.g., in the three-dimensional (3D) space, needs to be sufficiently large to cover a desired range of the surroundings laterally and vertically. In addition, the number of scanning angles, e.g., the individual directions at which laser beam 214 is directed, also needs to be sufficiently large. Thus, the scanning rate (e.g., the speed at which scanner 212/receiver 222 needs to sweep across multiple angles) needs to be sufficiently high. Conventional laser beam steering technologies, such as mechanical movement-based steering mechanisms, are limited by the rate of rotation (e.g., in case of rotational LiDAR systems) or mirror vibration (e.g., in case of MEMS-based LiDAR systems). These conventional systems are also very expensive to make and maintain. Embodiments of the present disclosure provide non-mechanical laser beam steering mechanisms that address the above-mentioned problems.

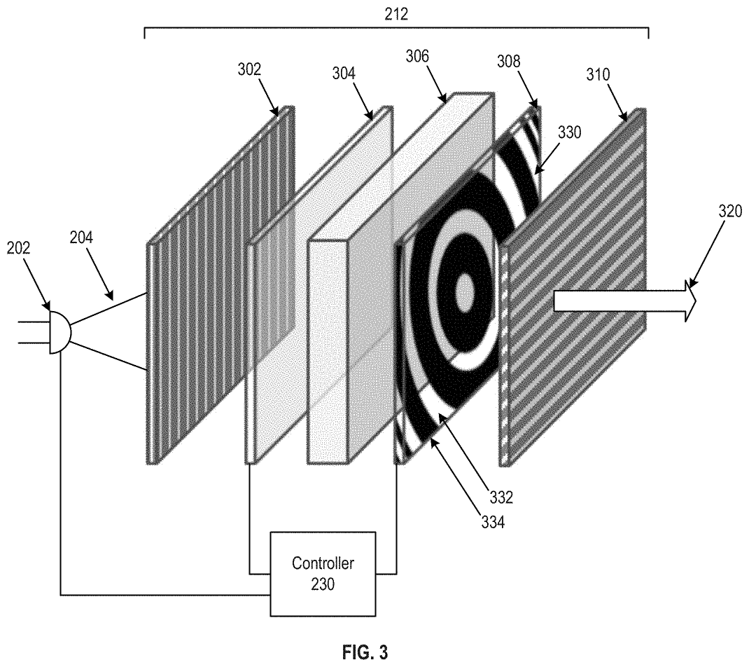

FIG. 3 shows an exemplary implementation of scanner 212, according to embodiments of the disclosure. As shown in FIG. 3, scanner 212 may include several components disposed in parallel, or substantially in parallel. Scanner 212 may include a first polarizer 302 disposed close to laser source 202. Polarizer 302 may be configured to polarize laser beam 204 emitted from laser source 202. For example, polarizer 302 may be a linear polarizer that includes a grid of wires. Laser beam waves having a component of their electric field aligned parallel to the wires cannot pass the polarizer, while laser beam waves with electric filed perpendicular to the wires can pass the polarizer. As a result, the portion of laser beam 204 passing through polarizer 302 may be polarized in the same polarization direction. For simplicity, the portion of laser beam 204 that passes through polarizer 302 is referred to as the polarized laser beam 204.

Scanner 212 may also include first transparent electrode 304 and second transparent electrode 308, and a liquid crystal 306 sandwiched between the two transparent electrodes, as shown in FIG. 3. Transparent electrodes 304 and 308, by themselves, may be transparent to polarized laser beam 204 such that polarized laser beam 204 may pass through them. However, transparent electrode 304 and 308 may, through establishing electric field across liquid crystal 306, cause liquid crystal 306 to selectively alter one or more properties of polarized laser beam 204, such that certain portions of polarized laser beam 204 may be blocked by a second polarizer 310 disposed in parallel with transparent electrode 308 and also disposed further away from polarizer 302 than transparent electrode 308. For example, controller 230 may apply a signal to either transparent electrode 304 or 308 to create electric field across liquid crystal 306. For simplicity, hereinafter it is assumed that the signal is applied to transparent electrode 308 while transparent electrode 304 is used as a reference electrode. The electric field may be inhomogeneous such that in certain regions of liquid crystal 306 the liquid crystal molecules align along the polarization direction of polarized laser beam 204 due to the effect of the electric field, thereby maintaining the polarization direction of the polarized laser beam 204 and allowing passage therethrough with no significant alteration of its polarization direction. This part of polarized laser beam 204 (e.g., passing through liquid crystal 306 while maintaining its polarization direction) can be blocked by polarizer 301, which may be configured to polarize laser beams in a direction that is perpendicular to the polarization direction of polarizer 302, as shown in FIG. 2. On the other hand, some regions of liquid crystal 306 may be subject to little or no electric field, and the structure of liquid crystal molecules in these regions may alter the polarization direction of polarized laser beam 204, for example, by 90 degrees or so, such that the altered polarization direction substantially align with the polarization direction of polarizer 320, which allows passage of the polarized laser beam 204 (e.g., with the altered polarization direction) through polarizer 310. In this way, the combination of polarizers 302, 310, transparent electrodes 304, 308, liquid crystal 306, and the signal may function as a Fresnel zone plate that selectively block certain parts of laser beam 204 while allowing other parts of laser beam 204 to pass through.

In some embodiments, the selectivity may be achieved by a pattern 330 generated on transparent electrode 308 (or 304 under the same principle, hereinafter using transparent electrode 308 as an example). For example, transparent electrode 308 may include a plurality of excitable regions that, when excited by the signal provided by controller 230, collectively assemble pattern 330. The plurality of excitable regions may include a first type of regions 334, shown by darker colors in FIG. 3, for blocking the polarized laser beam 204 passing through liquid crystal 306; and a second type of regions 332, shown by lighter colors in FIG. 3, that allow passage of the polarized laser beam 204 passing through liquid crystal 306. In some embodiments, these two types of regions may be pre-assigned and selectively excited by the signal. In some embodiments, transparent electrode 308 may include a grid of pixels, and the two types of regions may correspond to two states of the pixels (e.g., on/off, lighter/darker, two different colors, etc.) that can be switched back and forth in response to the signal applied to transparent electrode 308 by controller 230. Through controlling the profile of pattern 330 (e.g., shape, position, size of the two types of regions), the direction of laser beam 320 passing through polarizer 310 can be controlled (e.g., steered).

As discussed above, the inhomogeneous electric field generated across liquid crystal 306 may cause selective alteration of at least one property of the polarized laser beam 204 passing through liquid crystal 306. For example, pattern 330 may correspond to the inhomogeneity of the electric field, where the first type of regions 334 may be excited by the signal to establish electric field together with transparent electrode 304 (e.g., the reference electrode) and apply the electric field to the underlying portions of liquid crystal 306, such that polarized laser beam 204 passing through those underlying portions of liquid crystal maintains its polarization direction, and be blocked by polarizer 310 that has an orthogonal or perpendicular polarization direction. Similarly, the second type of regions 332 may apply little or no electric field to the underlying portions of liquid crystal 306, which in turn alter the polarization direction of polarized laser beam 204 to be aligned with the polarization direction of polarizer 310, thereby allowing the laser beam to pass through polarizer 310. As used herein, an “underlying” portion of liquid crystal 306 means that the surface area of that portion overlaps or substantially overlaps with a particular type of region (e.g., 332 or 334) on transparent electrode 308 for generating pattern 330.

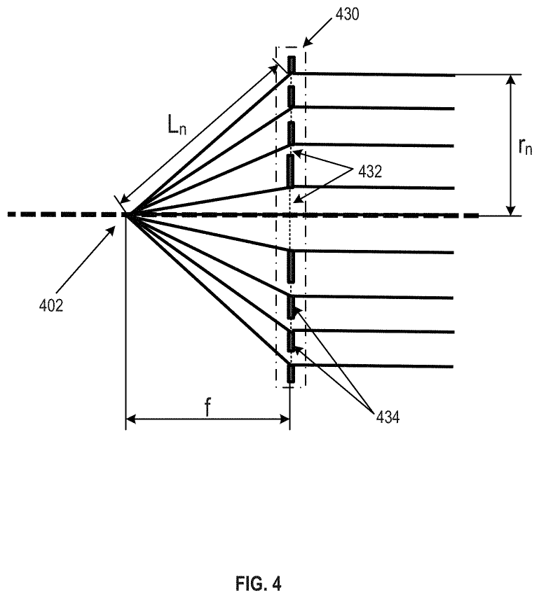

As discussed above, scanner 212 may function as a Fresnel zone plate (hereinafter referred to as a “zone plate”), and pattern 330 may define the profile of the zone plate, thereby defining its optical property. By controlling pattern 330 using the signal provided by controller 230, scanner 212 may control the direction of laser beam 320 passing through polarizer 310 and emitted to the surroundings of LiDAR system 102. FIG. 4 illustrates an exemplary zone plate 430 that can be implemented by a pattern (e.g., pattern 330) generated on transparent electrode 308 for directing laser beams, according to embodiments of the disclosure. As shown in FIG. 4, zone plate 430 may be formed by a series of alternating opaque zones 434 and transparent zones 432. Depending on whether light signals are emitted from or focused at a focal point 402, the direction of the emitted or incident light beams can be controlled by changing the sizes of the opaque and/or transparent zones. For example, in the normal emission/incidence case (e.g., the direction of the light beams is perpendicular to the surface of zone plate 430) shown in FIG. 4, the linear distance from focal point 402 to the boundaries between adjacent opaque and transparent zones Lₙ has the following relationship with focal length f:

$${L}_{n} - f = \frac{n λ}{2}$$

where λ is the wavelength of the light beams passing through zone plate 430. The radii rₙ at which to switch between opaque and transparent can be calculated as:

$${r}_{n} = \sqrt{n λ ( f + \frac{n λ}{4} )} \qquad ( 1 )$$

When the opaque zones 434 and transparent zones 432 are constructed according to rₙ in equation (1), the direction of the laser beams passing through zone plate 430 is normal (e.g., perpendicular) to the surface of zone plate 430. The profile of the opaque and transparent zones can be implemented using a predetermined pattern (e.g., 330) generated on transparent electrode 308, in which the first type of regions 334 correspond to opaque zones 434 and the second type of regions 332 correspond to transparent zones 432. In this way, steering of a laser beam can be achieved by controlling the patterns generated on transparent electrode 308, where a particular pattern corresponds to a particular direction of the laser beam.

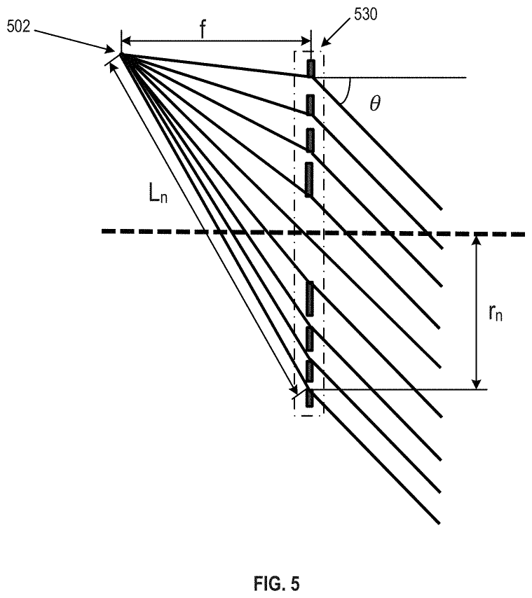

FIG. 5 shows another exemplary zone plate 530 where the direction of the light beams is not normal to the surface plane of the zone plate but oblique, e.g., defined by an angle θ. In this case, distance Lₙ and focal length f satisfy the follow equation:

$${L}_{n} - \frac{f}{cos θ} - {r}_{n} sin θ = \frac{n λ}{2}$$

and the radii rₙ at which to switch between opaque and transparent zones is:

$${r}_{n} = \frac{n λ sin θ + \sqrt{{n}^{2} {λ}^{2} + 4 n λ f cos θ}}{2 {cos }^{2} θ} \qquad ( 2 )$$

rₙ calculated from equation (2) can be used to generate a pattern on transparent electrode 308 to direct the laser beam passing through polarizer 310 along a θ-angle direction.

In FIG. 5, focal point 502 may be the same as focal point 402 in FIG. 4, both corresponding to laser source 202 in FIG. 2 when zone plate 430 and 530 shown in FIGS. 4 and 5, respectively, are used for directing laser beams toward the surroundings. Compared to FIG. 4, the center of zone plate 530 shown in FIG. 5 may be seen as being shifted downward when the position of the focal point stays the same.

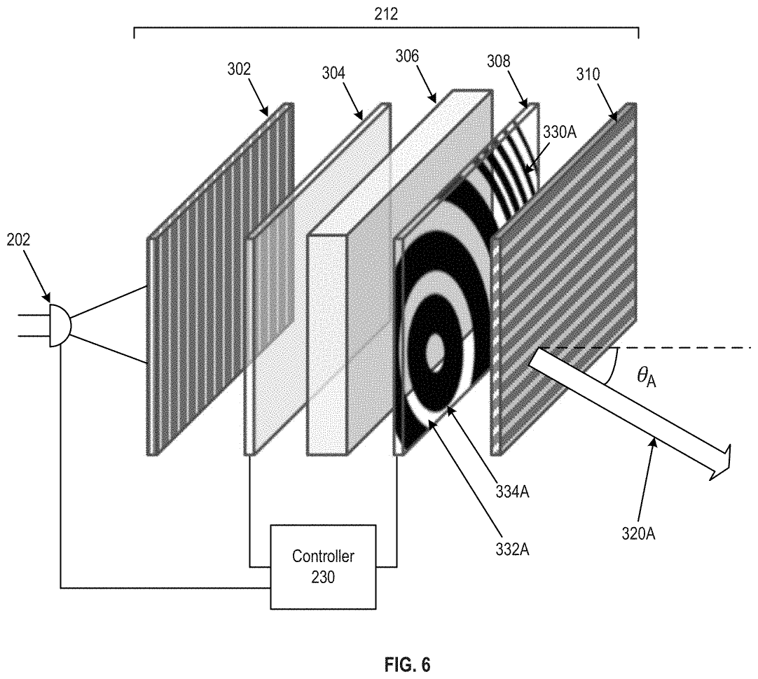

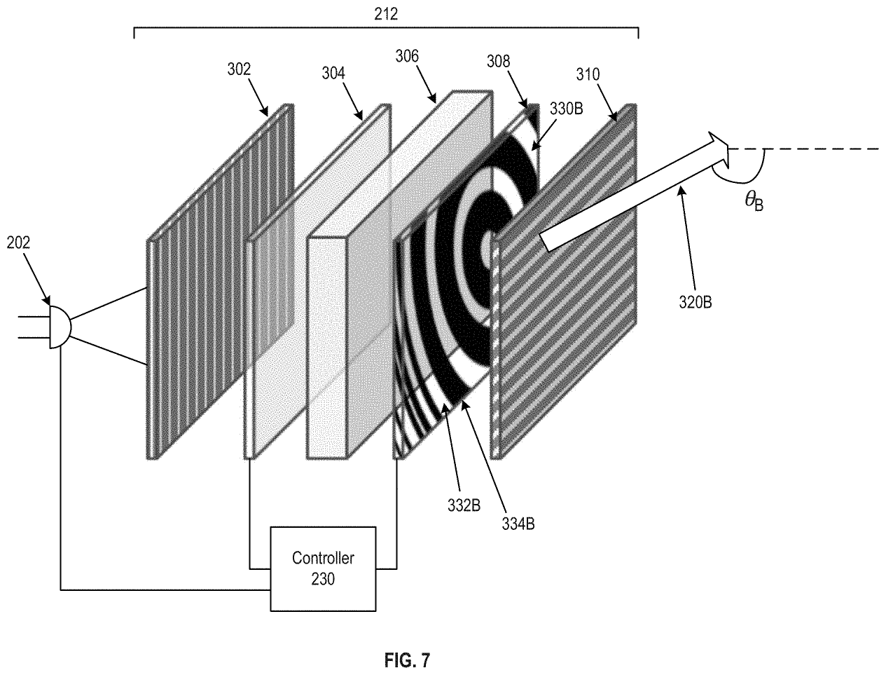

FIGS. 6 and 7 show exemplary patterns 330A and 330B for directing laser beams 320A and 320B, respectively, into two oblique directions. As shown in FIG. 6, pattern 330A includes the first type of regions 334A, corresponding to the opaque zones of a zone plate, for blocking the polarized laser beam passing through liquid crystal 306 at polarizer 310; and the second type of regions 332A, corresponding to the transparent zones of a zone plate, that allows passage of the polarized laser beam through polarizer 310. The radii at the boundary between adjacent first and second types of regions, measured from the center of the corresponding zone plate, are governed by equation (2) for the angle of emission θ_{A}. Similarly, in FIG. 7, first and second types of regions 334B and 332B, respectively, collectively assemble pattern 330B for directing laser beam 320B along an oblique direction defined by emission angle θ_{B}.

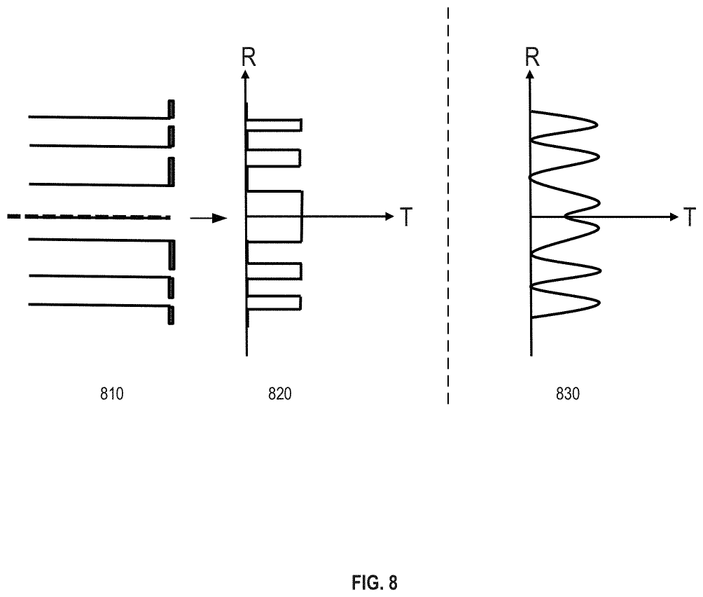

In addition to the linear or binary zone plate examples shown in FIGS. 4 and 5, other types of zone plates may also be used. FIG. 8 shows a comparison between a linear/binary zone plate and a sinusoidal zone plate. As shown in FIG. 8, the transmission profile of a linear/binary zone plate 810 is shown in 820, in which the transmission rate T switches between two values indicating transparent and opaque, as defined by the following equation:

$${T}_{F Z} = \{ \begin{matrix}1 , {r}_{2 m} \leq r < {r}_{2 m + 1} \\ 0 , {r}_{2 m + 1} \leq r < {r}_{2 m + 2}\end{matrix} .$$

The transmission profile of a sinusoidal zone plate is shown in 830, in which the transmission rate varies according to a sinusoidal waveform, as defined by the following equation:

$${T}_{S F Z} = \frac{1}{2} [ 1 + β sin ( \frac{π {r}^{2}}{λ f} ) ] .$$

Embodiments of the present disclosure can use any suitable type of zone plates, including the linear/binary type and the sinusoidal type shown in FIG. 8.

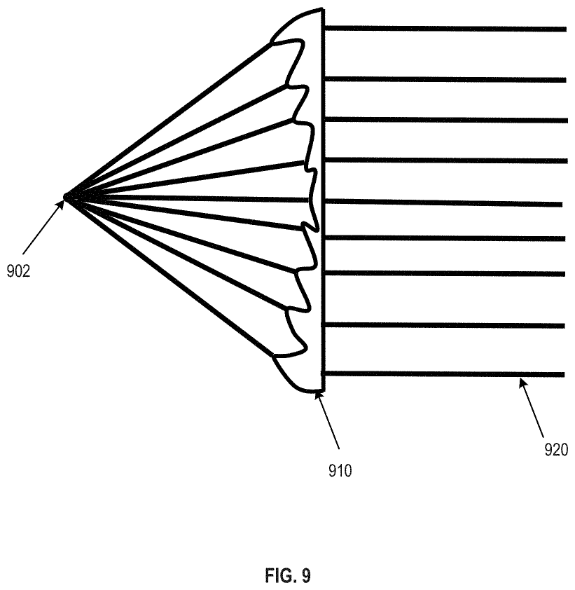

The zone plate-based laser beam steering system disclosed above can be cataloged as intensity-modulation systems, because the intensity of the laser beam is modulated by the zone plate to achieve the light direction steering function. Alternatively, laser beam steering may also be achieved by modulating the phase of the laser beams. Phase-modulation systems may be constructed based on the principle of a Fresnel lens. An exemplary Fresnel lens 910 is shown in FIG. 9, which can be used to collimate light beams emitted by a light source (e.g., laser source 202) placed at the focal point 902 into directional light beams 920. Fresnel lens 910 can be implemented using a combination of a polarizer, a pair of transparent electrodes, and a liquid crystal, similar to scanner 212. For normal (e.g., perpendicular to the vertical surface of Fresnel lens 910) emission/incidence, the phase requirements are as follows:

$$ϕ ( r ) = 2 π ( n - \frac{{r}^{2}}{2 {λ}_{0} f} ) , {r}_{n - 1} \leq r < {r}_{n} .$$

The radii at the boundaries between adjacent zones are:

rₙ=\sqrt{2λ₀fn},n=1,2,3, . . . ,N. (3)

For oblique emission/incidence:

$$ϕ ( r ) = 2 π ( n - \frac{{r}^{2}}{2 {λ}_{0} f} ) , {r}_{n - 1} \leq r < {r}_{n} ;$$

and the radii are:

$${r}_{n} = \frac{2 n λ sin θ + \sqrt{4 {n}^{2} {λ}^{2} + 8 n λ f cos θ}}{2 {cos }^{2} θ} , n = 1 , 2 , 3 , … , N . \qquad ( 4 )$$

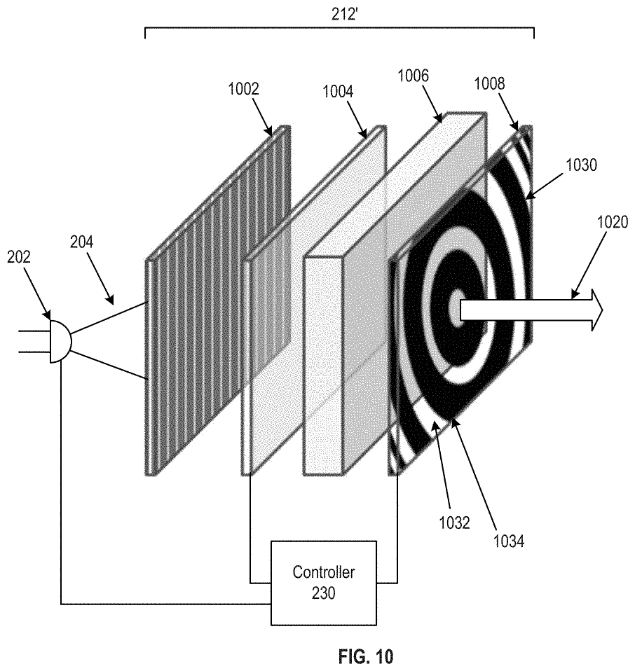

FIG. 10 shows an exemplary scanner 212′ for steering laser beams based on phase modulation. As shown in FIG. 10, scanner 212′ may include a polarizer 1002, first and second transparent electrodes 1004 and 1008, and a liquid crystal 1006 sandwiched between transparent electrodes 1004 and 1008. Compared to scanner 212 shown in FIG. 3, scanner 212′ may have similar components (e.g., polarizer 1002, transparent electrode 1004, liquid crystal 1006, and transparent electrode 1008 may be similar to polarizer 302, transparent electrode 304, liquid crystal 306, and transparent electrode 308, respectively), without using a second polarizer next to transparent electrode 1008. In addition, the signal provided by controller 230 for generating a pattern 1030 on one of the transparent electrodes (e.g., transparent electrode 1008) may be different from the signal for generating pattern 330. Pattern 1030, which corresponds to a Fresnel lens pattern, may also be different from pattern 330 corresponding to a zone plate pattern. Instead of altering the polarization direction of the polarized laser beam 204 as in scanner 212, pattern 1030 may cause the underlying portion of liquid crystal 1006 to alter the phase of polarized laser beam 204. For example, the signal applied to transparent electrode 1008 may cause different electric fields to be generated in a first type of regions 1034 and in a second type of regions 1032, which may in turn cause the corresponding underlying portions of liquid crystal 1006 to have different refractive indices, thereby altering the phase of the polarized laser beam 204 passing therethrough. The boundary between first and second types of regions may be determined according to equations (3) or (4), depending on the direction to which laser beam 1020 is directed. In this way, laser beam steering can be achieved by applying a plurality of signals to transparent electrode 1008 to generate a series of predetermined patterns, each corresponding to a specific direction. Scanning of the surrounding may be implemented by sweeping a sequence of patterns to direct the laser beam toward the corresponding sequence of directions.

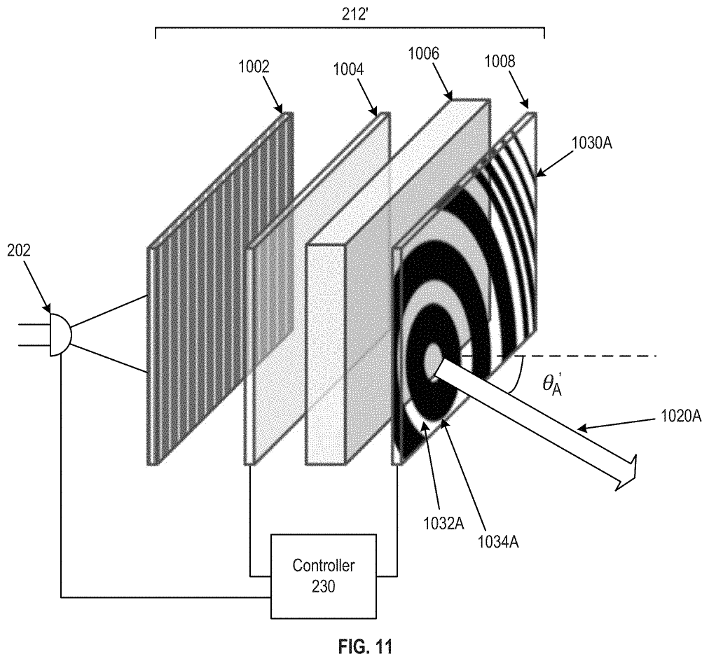

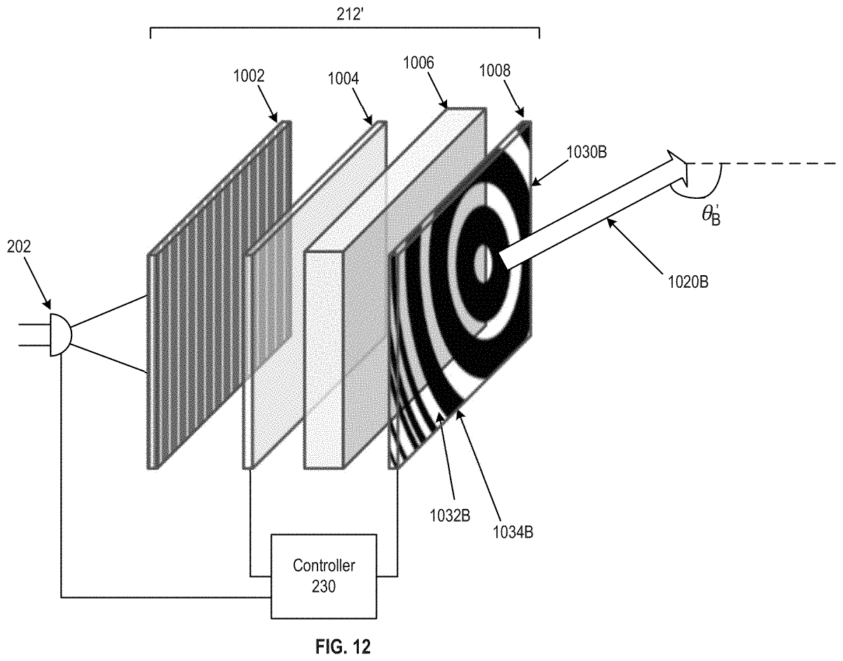

FIGS. 11 and 12 show exemplary patterns 1030A and 1030B for directing laser beams 1020A and 1020B, respectively, into two oblique directions using scanner 212′. As shown in FIG. 11, pattern 1030A includes the first type of regions 1034A and second type of regions 1032A for altering the phases of the laser beams passing through corresponding portions of liquid crystal 1006 differently. The radii at the boundary between adjacent first and second types of regions are governed by equation (4) for a particular angle of emission θ_{A}. As a result, laser beam 1020A is directed downward, as shown in FIG. 11. Similarly, pattern 1030B shown in FIG. 12 includes the first type of regions 1034B and second type of regions 1032B for phase modulation. Compared to pattern 1030A, the radii at the boundary between adjacent first and second types of regions in pattern 1030B are governed by equation (4) for another angle of emission θ′_{B}. As a result, laser beam 1020B is directed upward as shown in FIG. 12.

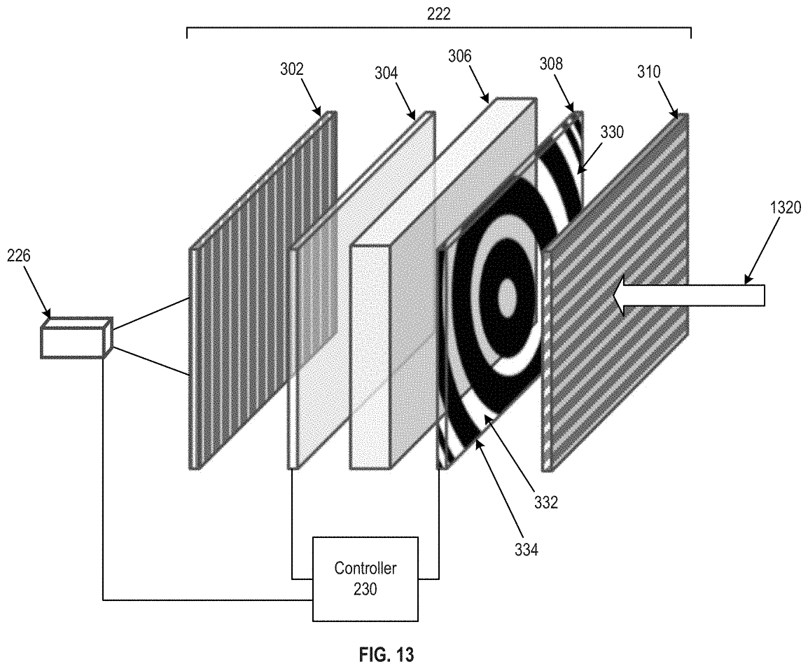

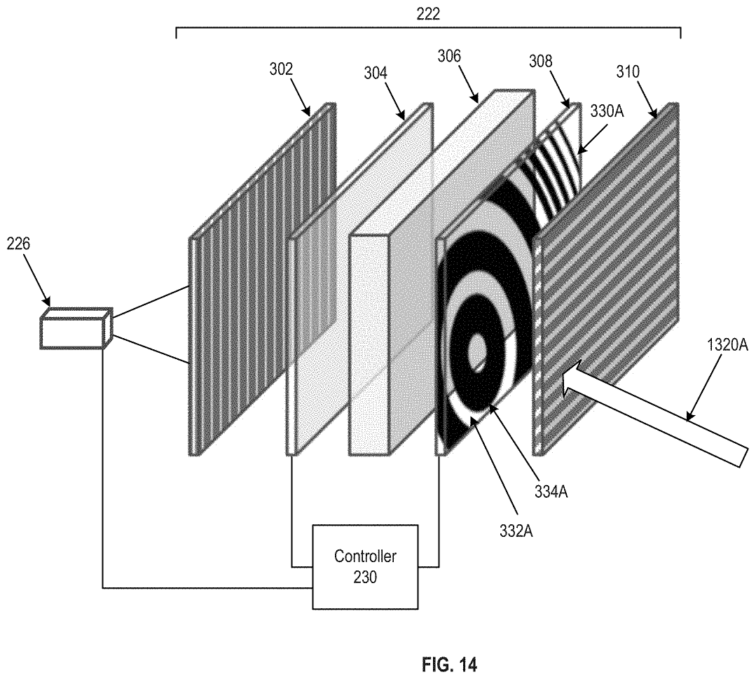

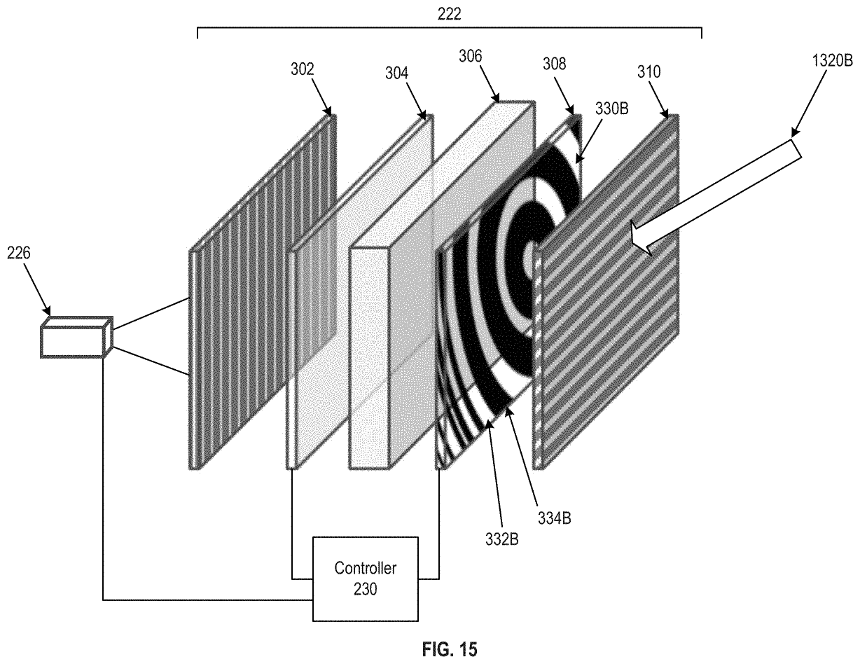

The above disclosed embodiments show various laser beam steering techniques in the context of a scanner (e.g., 212/212′), the same principle can be applied to receive laser beams reflected from different directions. FIGS. 13-15 show an exemplary implementation of receiver 222 based on the Fresnel zone plate principle using the same components as scanner 212 shown in FIGS. 3, 6, and 7. Instead of emitting laser beams 320/320A/320B to the surroundings as with scanner 212, receiver 222 can receive laser beams 1320/1320A/1320B incident from different directions and direct the received laser beams toward photodetector 226. The correspondence between the pattern generated on transparent electrode 308 and the receiving direction may be the same as that in the scanner case, where the radii of the boundaries between adjacent first and second types of regions are governed by equations (1) for normal incidence or (2) for oblique incidence. The operations of receiver 212 are similar to scanner 212 except the direction of the laser beams are reversed.

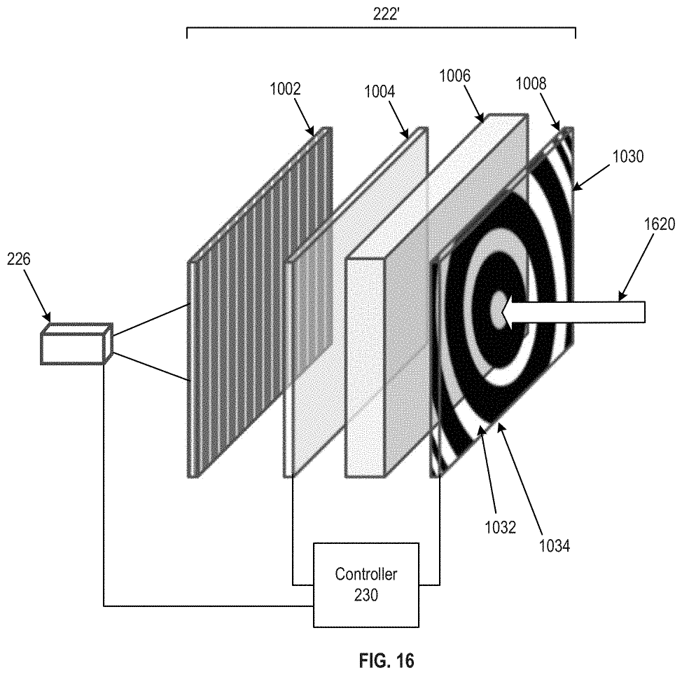

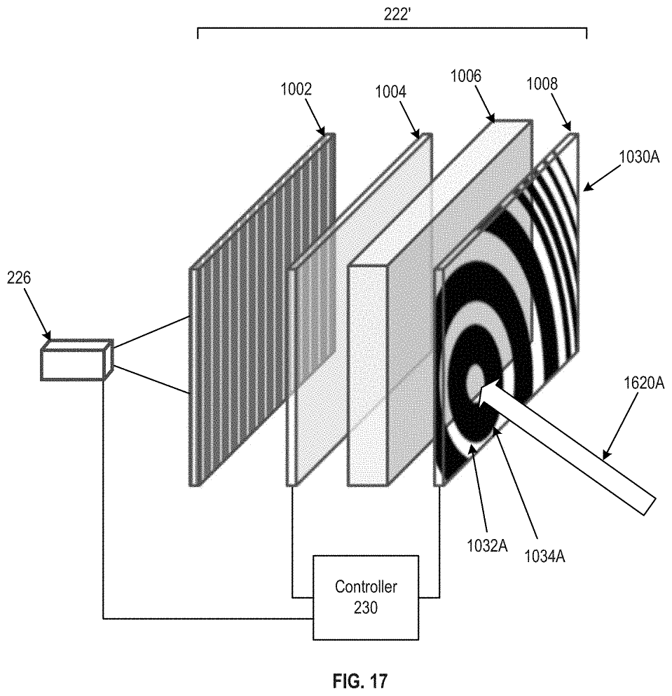

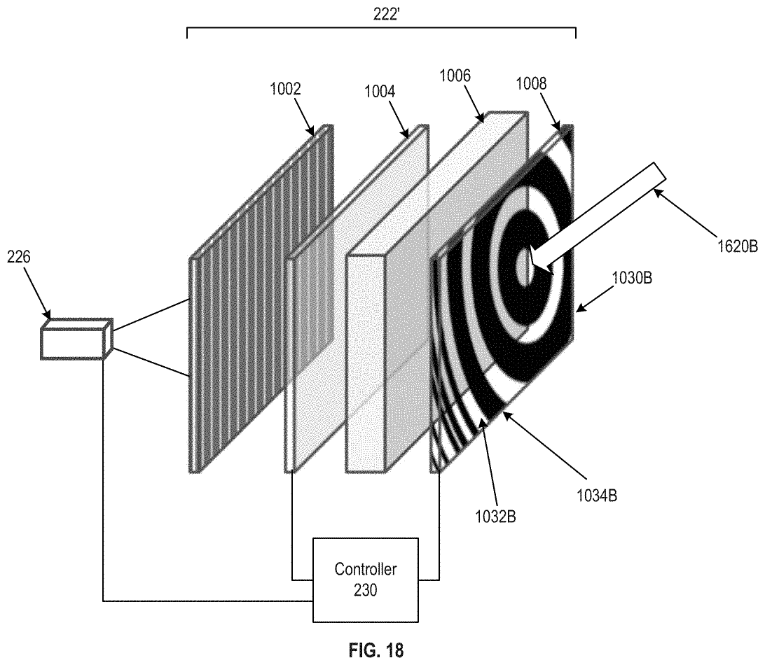

FIGS. 16-18 show an exemplary implementation of receiver 222′ based on the Fresnel lens principle using the same components as scanner 212′ shown in FIGS. 10-12. Instead of emitting laser beam 1020/1020A/1020B to the surroundings as with scanner 212′, receiver 222′ can receive laser beams 1620/1620A/1620B incident from different directions and direct the received laser beams toward photodetector 226. The correspondence between the pattern generated on transparent electrode 1008 and the receiving direction may be the same as that in the scanner case, where the radii of the boundaries between adjacent first and second types of regions are governed by equations (3) for normal incidence or (4) for oblique incidence. The operations of receiver 212′ are similar to scanner 212′ except the direction of the laser beams are reversed.

In some embodiments, controller 230 coupled to at least one of the transparent electrode(s) disclosed herein may be configured to generate a plurality of signals to be sequentially applied to the transparent electrode(s) to generate a sequence of predetermined patterns. Each pattern may correspond to a predetermined direction to which laser beams are directed or from which laser beams are received. In this way, scanning an FOV using laser beams or receiving reflected laser beams in a series of directions can be achieved by sweeping across a series of predetermined patterns. No mechanical moving part is needed.

Controller 230 may include any appropriate type of general-purpose or special-purpose microprocessor, digital signal processor, or microcontroller. Controller 230 may be configured as a stand-alone processor module dedicated to generating signals for laser beam steering. Alternatively, controller 230 may be configured as a shared processor module for performing other functions unrelated to laser beam steering.

It will be apparent to those skilled in the art that various modifications and variations can be made to the disclosed systems. Other embodiments will be apparent to those skilled in the art from consideration of the specification and practice of the disclosed systems.

It is intended that the specification and examples be considered as exemplary only, with a true scope being indicated by the following claims and their equivalents.

1. A laser beam scanner, comprising:
a first polarizer configured to polarize a laser beam emitted from a laser source;
first and second transparent electrodes disposed in parallel with the first polarizer, the first transparent electrode being closer to the first polarizer than the second transparent electrode; and
a liquid crystal disposed between the first and second transparent electrodes and configured to selectively alter at least one property of the laser beam polarized by the first polarizer in response to a signal applied to the first or second transparent electrodes,
wherein the signal generates a predetermined pattern on the first or second electrode to direct the laser beam polarized by the first polarizer to a predetermined direction corresponding to the predetermined pattern.

2. The laser beam scanner of claim 1, comprising:
a controller coupled to at least one of the first or second transparent electrode and configured to generate a plurality of signals to be sequentially applied to the first or second transparent electrode to generate a sequence of predetermined patterns, each pattern corresponding to a predetermined direction to which the laser beam polarized by the first polarizer is directed.

3. The laser beam scanner of claim 1, wherein:
at least one of the first or second transparent electrode comprises a plurality of excitable regions that, when excited by the signal, collectively assemble the predetermined pattern.

4. The laser beam scanner of claim 1, wherein:
at least one of the first or second transparent electrode comprises a grid of pixels that generate the predetermined pattern in response to the application of the signal.

5. The laser beam scanner of claim 1, wherein the predetermined pattern comprises:
a first type of regions for blocking the laser beam polarized by the first polarizer; and
a second type of regions allowing passage of the laser beam polarized by the first polarizer.

6. The laser beam scanner of claim 5, comprising:
a second polarizer disposed in parallel with the second transparent electrode and further away from the first polarizer than the second transparent electrode,
wherein:
the first polarizer is configured to polarize the laser beam in a first polarization direction;
the second polarizer is configured to polarize the laser beam in a second polarization direction that is perpendicular to the first polarization direction;
the first type of regions, upon application of the signal, cause molecules of an underlying portion of the liquid crystal to align along the first polarization direction and maintain a polarization direction of the laser beam passing therethrough, thereby blocking the laser beam at the second polarizer; and
a portion of the liquid crystal underlying the second type of regions alters the polarization direction of the laser beam passing therethrough from the first polarization direction to the second polarization direction, thereby allowing passage of the laser beam through the second polarizer.

7. The laser beam scanner of claim 5, wherein the predetermined pattern comprises a Fresnel zone plate pattern.

8. The laser beam scanner of claim 7, wherein:
the first type of regions corresponds to opaque zones of the Fresnel zone plate pattern; and
the second type of regions corresponds to transparent zones of the Fresnel zone plate pattern.

9. The laser beam scanner of claim 1, wherein the predetermined pattern comprises a plurality of regions, and each of the plurality of regions, upon application of the signal, causes a corresponding underlying portion of the liquid crystal to alter a phase of the laser beam passing therethrough, thereby directing the laser beam toward the predetermined direction.

10. The laser beam scanner of claim 9, wherein the plurality of regions assemble a Fresnel lens pattern.

11. A laser signal receiver, comprising:
first and second transparent electrodes disposed in parallel with each other;
a liquid crystal disposed between the first and second transparent electrodes and configured to selectively alter at least one property of a laser beam passing therethrough in response to a signal applied to the first or second transparent electrodes, wherein the signal generates a predetermined pattern on the first or second electrode to direct the laser beam from a predetermined direction toward a photodetector; and
a first polarizer disposed in parallel with the first and second transparent electrodes and configured to polarize the laser beam passing through the liquid crystal.

12. The laser signal receiver of claim 11, comprising:
a controller coupled to at least one of the first or second transparent electrode and configured to generate a plurality of signals to be sequentially applied to the first or second transparent electrode to generate a sequence of predetermined patterns, each pattern corresponding to a predetermined direction from which the laser beam is received by the laser beam receiver.

13. The laser signal receiver of claim 11, wherein:
at least one of the first or second transparent electrode comprises a plurality of excitable regions that, when excited by the signal, collectively assemble the predetermined pattern.

14. The laser signal receiver of claim 11, wherein:
at least one of the first or second transparent electrode comprises a grid of pixels that generate the predetermined pattern in response to the application of the signal.

15. The laser signal receiver of claim 11, wherein the predetermined pattern comprises:
a first type of regions for blocking the laser beam; and
a second type of regions allowing passage of the laser beam.

16. The laser signal receiver of claim 15, comprising:
a second polarizer disposed in parallel with the second transparent electrode and further away from the photodetector than the first polarizer,
wherein:
the first polarizer is configured to polarize the laser beam in a first polarization direction;
the second polarizer is configured to polarize the laser beam in a second polarization direction that is perpendicular to the first polarization direction;
the first type of regions, upon application of the signal, cause an underlying portion of the liquid crystal to align along the second polarization direction and maintain a polarization direction of the laser beam passing therethrough, thereby blocking the laser beam at the first polarizer; and
a portion of the liquid crystal underlying the second type of regions alters the polarization direction of the laser beam passing therethrough from the second polarization direction to the first polarization direction, thereby allowing passage of the laser beam through the first polarizer.

17. The laser signal receiver of claim 15, wherein the predetermined pattern comprises a Fresnel zone plate pattern.

18. The laser signal receiver of claim 17, wherein:
the first type of regions corresponds to opaque zones of the Fresnel zone plate pattern; and
the second type of regions corresponds to transparent zones of the Fresnel zone plate pattern.

19. The laser signal receiver of claim 11, wherein the predetermined pattern comprises a plurality of regions, and each of the plurality of regions, upon application of the signal, causes a corresponding underlying portion of the liquid crystal to alter a phase of the laser beam passing therethrough, thereby directing the laser beam from the predetermined direction toward the photodetector.

20. The laser signal receiver of claim 19, wherein the plurality of regions assemble a Fresnel lens pattern.
